(19) United States
(12) Patent Application Publication
(10) Pub. No.: US 2007/0060429 A1
(43) Pub. Date: Mar. 15, 2007

(54) Chain and method for blanking hole in chain plate

(76) Inventors: Takuma Ono, Ishikawa (JP); Shigeo Murai, Ishikawa (JP)

Correspondence Address: WENDEROTH, LIND & PONACK, L.L.P., 2033 K STREET N. W., SUITE 800, WASHINGTON, DC, 20006-1021, US

(21) Appl. No.: 11/519,784

(22) Filed: Sep. 13, 2006

(30) Foreign Application Priority Data
Sep. 15, 2005 (JP) 2005-268081

(51) Int. Cl. F16G 13/02; F16G 1/28; F16G 5/20

(52) U.S. Cl. 474/230; 474/202

(57) ABSTRACT

In blanking holes in plates that comprise a chain, in order to improve the fatigue strength of the chain, a press-punched plate prepared hole, trumpet-shaped, is shaved and made into a straight hole, both ends of the straight hole are chamfered, and further, a multi-step burnishing punch composed of a plurality of annular convex portions at predetermined intervals is pressed into the straight hole, improving the dimensional accuracy of the hole and the smoothness of the hole wall and producing compressive residual stress in the hole wall.

### BACKGROUND OF THE INVENTION

1. Field of the Invention

The present invention relates to a method for blanking a hole in a chain plate and a chain made using the method for blanking a hole in a chain plate.

2. Related Art

In order to improve the strength of a conveyer chain or a power transmission roller chain, and in particular the fatigue strength of the chain, it is necessary to enhance the dimensional accuracy and surface smoothness of the pin holes and the bush holes formed in the chain plates that comprise the chain. The chain plates are usually press-punched, and therefore the sheared section of the hole constitutes no more than a portion of the whole, with the majority constituting a broken-out section. Cracks appear in the hole wall starting from this broken-out section, causing the plate to break. Thus, blanking holes without such broken-out sections becomes a prerequisite for enhancing the fatigue strength of the plates and ultimately of the chain itself.

Conventionally, press shearing that does not create a broken-out section is also known. For example, fine blanking (precision blanking) and shearing using opposed dies are well known. By raising the hydrostatic pressure on a metal sheet to be blanked locally at the broken-out section, these shearing methods improve the ductility of the metal and do not create broken-out sections. Examples include the “Fine Blanking Device” of JP-A-2004-181481, the “Precision Blanking Method, Die Assembly and Hydraulic Press” of JP-A-2002-331321, the “Opposed Die Shearing Die” of JP-A-05-50157, and the “Shearing Device and Shearing Method Using Opposed Dies” of JP-A-2005-14062.

However, the ordinary presses that are commonly used cannot be used with these methods, and moreover, the blanking molds must be of a special construction. In addition, blanking speed is slow and thus productivity inevitably declines. Therefore, these methods are unsuitable for the press blanking of chain plates that must be mass-produced.

Conventionally, in order to improve plate dimensional accuracy of the holes and enhance the fatigue strength of the chain plate, a ball-penetration process and a bar-penetration process have been carried out In other words, as shown in FIG. 6A, with respect to chain plate (a) dimensional accuracy of the holes, for a hole blanked in a state in which the chain plate is press-punched, a punch descends from above the plate and blanks a hole, but such blanked hole (b) is trumpet-shaped, with the inner diameter at the bottom of the hole enlarged, and the sheared section (c) having no more than a portion at the top of the hole and most of the hole composed of a trumpet-shaped broken-out section (d). After this press blanking, shaving is carried out so that, as shown in FIG. 6B, the hole becomes a substantially straight shaved hole (e). However, the shaving produces vertical striations in the walls of the hole, creating tensile residual stress in the circumferential direction.

FIG. 6C shows a cross-section of a ball-penetration hole (f) produced by passing a ball through the shaved hole (e) described above. Although the result appears to be a substantially straight ball-penetration hole (f) producing a hole wall (g) in which the broken-out section (d) has disappeared, in actuality numerous small grooves (h), (h) . . . remain in the hole wall (g). When a load is exerted on the chain, cracks appear starting from these grooves (h) and the plate experiences fatigue break. In addition, the ball-penetration hole (f) is often drum-shaped, with a very slight bulge at the middle as shown in FIG. 6C, and does not attain sufficient strength.

### SUMMARY OF THE INVENTION

Accordingly, it is one object of the present invention to solve the problems of the conventional art as described above and provide a chain and chain plate hole blanking method that uses a simpler device to process the walls of blanking holes to provide greater fatigue strength than that achieved using conventional ball-penetration processing.

To achieve the above object, a chain according to the present invention includes inner and outer plates whose holes are burnished holes produced using multi-step burnishing, with the chain assembled so that the outer plates are disposed in such a way that a direction of burnishing of said burnished holes is disposed outward.

In other words, although the basic structure of the chain is the same as the conventional art the holes in the plates that form the chain are the distinctive feature of the present invention.

The outer form of and the prepared holes in the plates are made by press punching and the plates are annealed. The prepared holes are shaved and then multi-step burnishing is carried out, thus greatly improving the dimensional accuracy of the holes and in particular the smoothness of the walls of the holes. This is a marked improvement over the conventional ball-penetration and bar-penetration processes.

If the chain is composed of outer links with pins inserted into holes in the outer plates, and inner links with bushes inserted in holes in the inner plates, with the outer links and the inner links connected so as to be mutually flexible, then preferably the chain is assembled so that the outer plates are disposed in such a way that the direction of burnishing of said burnished holes is disposed outward, and the inner plates are disposed in such a way that the direction of burnishing of the burnished holes is disposed inward.

Preferably, in the outer links the pins are pressed into the outer plates and in the inner links the bushes are pressed into the inner plates.

If the chain is a leaf chain or a silent chain composed of a plurality of plates flexibly connected by pins, then preferably the chain is assembled so that outermost plates on both sides of the chain into which said pins are pressed are disposed in such a way that the direction of burnishing of said burnished holes is disposed outward.

Preferably, the burnished holes are made by press punching to obtain prepared holes, shaving the prepared holes, and then carrying out multi-step burnishing to the shaved holes. The dimensional accuracy of the holes is further improved by burnishing the holes after chamfering.

In blanking holes in the plates that make up the chain according to the present invention, preferably, the trumpet-shaped or reverse-trumpet-shaped prepared holes formed by press-punching are shaved to form substantially straight holes, and multi-step burnishing is carried out by inserting a multi-step burnishing punch composed of a plurality of annular convex portions formed at predetermined intervals into such straight holes so as to improve the smoothness of the hole wall as well as generate compressive residual stress in such hole wall. As a result, the fatigue strength of the plates is greatly improved.

Preferably, the direction in which the burnishing punch is inserted into the hole is the reverse of that of the shaving, thus further improving the effect.

The holes in the plates that form the chain according to the present invention are subjected to multi-step burnishing after being press-punched, and the plates then assembled to form the chain, providing the following advantages:

(1) Improved Plate Hole Dimensional Accuracy

By multi-step burnishing of the press-punched plate prepared hole after the hole is shaved, the present invention provides greatly improved dimensional accuracy of the hole and particularly of the surface smoothness of the hole wall. In addition, the dimensional accuracy of the diameter of the hole and the surface smoothness are even further improved by performing burnishing after chamfering the ends of the hole.

(2) Improved Pressed Insertion Force

The dimensional accuracy of the hole and the smoothness of the hole wall are improved by multi-step burnishing. In addition, by generating a large compressive residual stress in the circumferential direction of the hole, the force with which the pins and the bushes are inserted into the plate holes can be increased. Increasing the pressed insertion force on the plate increases the antirotary power of the pins and the bushes, the pins and the bushes are held with greater force, and frictional wear in the plate holes caused by rotation of the pins and the bushes during operation of the chain can be prevented from occurring.

(3) Improved Plate Fatigue Strength

Multi-step burnished plate holes have improved dimensional accuracy and wall surface smoothness, and moreover a large compressive residual stress is generated in the circumferential direction of the hole wall. As a result, the fatigue strength of the plate is greatly improved. In addition, burnishing is carried out from a direction that is the opposite of the direction from which shaving is carried out, relieving axial tensile stress on the hole as well as reducing the appearance of cracks in the edge portions at the end of burnishing, thereby increasing the fatigue strength by approximately 20%. Furthermore, during assembly, the direction from which the pins are inserted in the holes is the same direction as that in which multi-step burnishing is done, and the direction from which the bushes are inserted in the holes is the opposite of that in which multi-step burnishing is done, thus increasing the fatigue strength of the chain.

Furthermore, plastic deformation of the multi-step-burnished hole increases at the beginning edge portions and the ending edge portions. In the present invention, since the hole contacts and engages the pins and the bushes in the holes at locations inward of the edges at which fatigue breaks originate, such fatigue brakes are that much harder to generate. If multi-step burnishing is performed after chamfering, the creation of points of origin of fatigue breaks can be reduced. Compressive residual stress is also provided by such chamfering, thus further increasing fatigue strength.

Other features and advantages of the present invention will be apparent from the following description when taken in conjunction with the accompanying drawings, in which like reference characters designate the same or similar parts throughout the figures thereof.

### BRIEF DESCRIPTION OF THE DRAWINGS

FIG. 1 is a diagram illustrating steps in a method of blanking a hole in a plate according to the present invention;

FIG. 2 is a 3-step burnishing punch used in the plate hole blanking method illustrated in FIG. 1;

FIG. 3 is a vertical section view of a plate burnished hole produced using multi-step burnishing;

FIG. 4 is a graph comparing fatigue strength of burnished holes in a plate produced using multi-step burnishing and fatigue strength of conventional blanked holes and ball-penetration holes;

FIG. 5 is a plan view of a chain using plates produced by multi-step burnishing; and

FIGS. 6A, 6B and 6C are schematic vertical sectional diagrams illustrating dimensional accuracy of the holes in a hole chain plate at each stage in the conventional ball-penetration process.

### DETAILED DESCRIPTION OF THE PREFERRED EMBODIMENTS

A detailed description will now be given of a preferred embodiment of the present invention, with reference to the accompanying drawings.

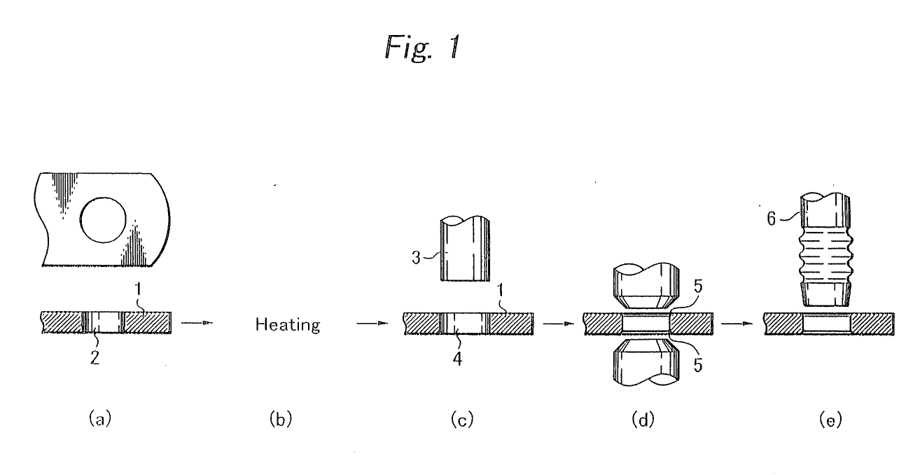

FIG. 1 shows steps in the processing of a plate according to the present invention, in which, first, in a step (a), a plate 1 is press-punched. A prepared hole 2 is formed in each end of the substantially oval-shaped chain plate 1. If the plate 1 is an outer plate, a pin is inserted in the prepared hole 2. If the plate 1 is an inner plate, a bush is inserted in the prepared hole 2. Then, in step (b), the press-punched plate undergoes heat treatment to give it the strength it needs to function as a part of a chain. The quenching temperature and the tempering temperature imparted to the chain plate 1 during heat treatment vary slightly depending on the plate material and the chain application.

Next, in step (c), the prepared holes 2 in the heat-treated plate 1 are shaved. In this embodiment, a shaving punch 3 is inserted into the prepared hole 2 to shave the press-punched, trumpet-shaped prepared hole 2. Shaving turns the trumpet-shaped prepared hole 2 into a straight hole 4. Then, in step (d), after shaving, the ends 5 of the straight hole 4 are chamfered.

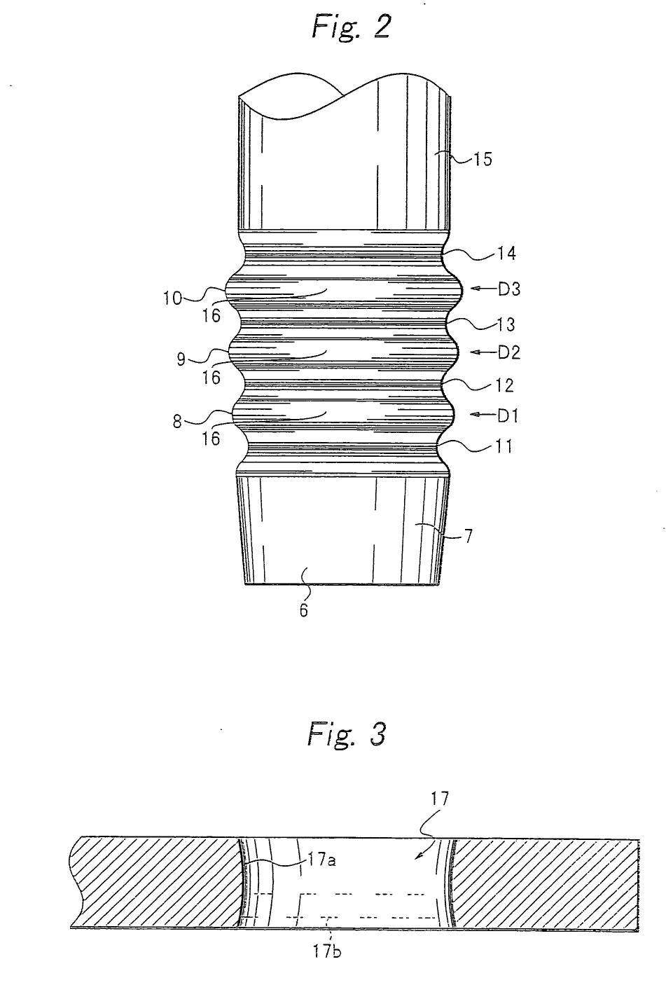

In step (e), a burnishing punch 6 is pressed into the chamfered straight hole 4 of plate 1 to burnish the hole 4. As shown in FIG. 2, the burnishing punch 6 has a 3-step convex portion that extends around the circumference of the burnishing punch 6. In other words, the burnishing punch 6 has, in order from a tip portion 7 of predetermined length, a first convex portion 8, a second convex portion 9 and a third convex portion 10 formed in that order, together with a first concave portion 11, a second concave portion 12, a third concave portion 13 and a fourth concave portion 14 formed alternately between each of the convex portions 8-10, and finally, an axial portion 15, respectively.

The first concave portion 11, second concave portion 12, third concave portion 13 and fourth concave portion 14 together forms a smooth curved surface. Although the peaks of the first convex portion 8, the second convex portion 9 and the third convex portion 10 form straight surfaces 16, 16, 16 of very slight width, their respective outer diameters D1, D2 and D3 are greater than the diameter of the tip portion 7, and moreover, differ slightly from each other. Specifically, D1<D2<D3. Therefore, when the burnishing punch 6 is pressed into the straight hole 4, the inner diameter of the straight hole 4 is successively widened by each of the first convex portion 8, the second convex portion 9 and the third convex portion 10 while at the same time the dimensional accuracy of the hole is improved, and moreover, the tiny grooves present in the hole wall 17a disappear, increasing the surface smoothness of the hole wall 17a to form a smooth varnish.

It should be noted that, instead of the straight surfaces 16, 16, 16 of slight width described above, alternatively, the peaks of the first convex portion 8, the second convex portion 9 and the third convex portion 10 may be formed as smooth curved surfaces.

In other words, by pressing the burnishing punch 6 into the straight hole 4, the straight hole 4 is scraped in stages by the first convex portion 8, the second convex portion 9 and the third convex portion 10 described above, the tiny grooves present in the straight hole 4 wall 17a are stretched and ultimately are eliminated, improving the dimensional accuracy and the smoothness of the hole wall 17a as well as generating an extremely large compressive residual stress that is useful in terms of the strength of the hole.

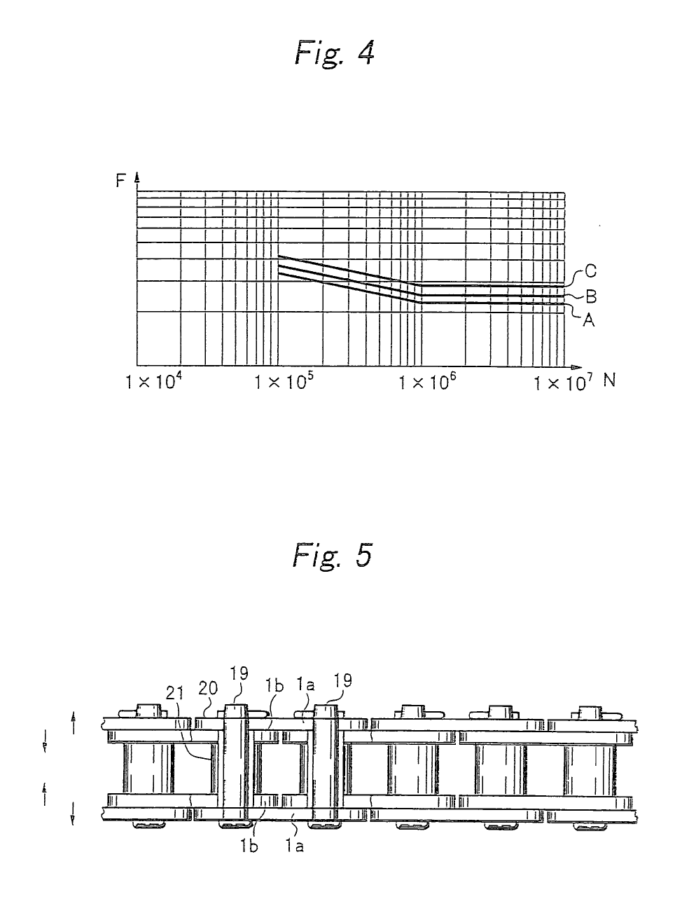

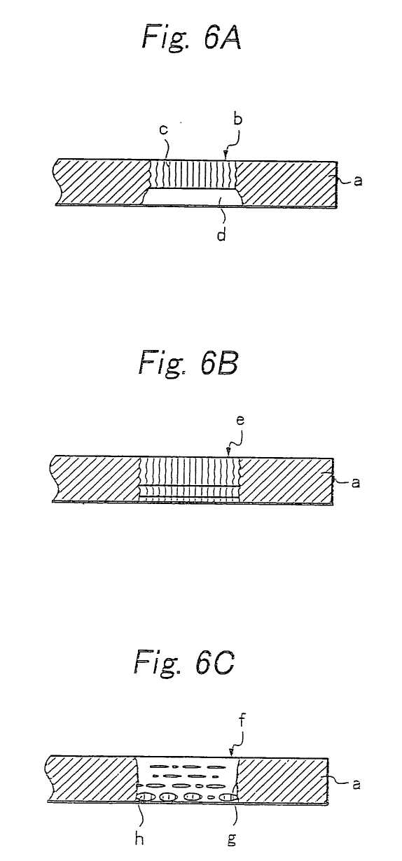

FIG. 3 is a diagram showing an enlarged view of a burnished hole 17 produced by multi-step burnishing. Although tiny grooves 17b, 17b . . . are present in the hole wall 17a, overall the wall 1 7a forms a smooth varnish. Comparing the fatigue strength of this sort of burnished hole 17 produced using multi-step burnishing with the fatigue strength of a press-punched hole A and a ball-penetration hole B yields, the results are as shown in the graph in FIG. 4. In other words, as shown in the graph, compared to the conventional press-blank hole (A), the conventional ball-penetration hole (B) represents a 40% improvement in fatigue strength and the multi-step burnished hole (C) represents an 80% improvement in fatigue strength.

FIG. 5 is a diagram showing a chain assembled using plates produced using multi-step burnishing. The chain is composed of outer plates 1a, inner plates 1b, pins 19, bushes 20 and rollers 21. The chain of the present invention is assembled in such a way that the outer plates 1a and the inner plates 1b are disposed in directions defined by the direction of burnishing. In other words, the outer plates 1a are disposed so that the direction of burnishing of the burnished holes 17, 17 . . . is outward as indicated by one set of arrows in FIG. 5, and the inner plates 1b are disposed so that the direction of burnishing of the burnished holes 17, 17 . . . is inward as indicated by the other set of arrows in FIG. 5.

However, although in the present invention the multi-step burnishing punch 6 is pressed into the straight hole 4 of the plate 1, in the case of a pressed and shaved straight hole 4 standard hole of poor dimensional accuracy, for example, one having a diameter of 35 mm with a tolerance of ±0.04 mm, a standard deviation of 0.015 and a process capability index of approximately Cₚ=0.45 (E rank), there will be a slight improvement in hole diameter accuracy with even a 1-step burnishing. However, using 2-step burnishing improves the standard deviation to 0.0057 and the process capability index to 1.17 (C rank).

In addition, the dimensional accuracy of the hole further improves with burnishing after chamfering. For example, when the straight hole 4 is chamfered and subjected to 1-step burnishing, standard deviation improves to approximately 0.0054 and the process capability index improves to approximately 1.23 (C rank). Moreover, 2-step burnishing improves standard deviation to approximately 0.004 and process capability index to approximately 1.68 (A rank).

At the same time, with respect to the pin insertion pressure, although in the case of the straight hole 4 the average value is approximately 19.3 kN, with 2-step burnishing the average value is 22.6 kN, a 17% improvement. Furthermore. if 3-step burnishing is performed after chamfering, the average value is 24.4 kN, an improvement of approximately 26%.

As many apparently widely different embodiments and variations of the present invention can be made without departing from the spirit and scope thereof, it is to be understood that the present invention is not limited to the specific embodiments thereof described herein but rather only to the extent set forth in the following claims.

1. A chain comprising inner and outer plates whose holes are burnished holes produced using multi-step burnishing,
the chain assembled so that the outer plates are disposed in such a way that a direction of burnishing of said burnished holes is disposed outward.

2. The chain according to claim 1, wherein the chain is composed of outer links with pins inserted into holes in the outer plates, and inner links with bushes inserted in holes in the inner plates, the outer links and the inner links connected so as to be mutually flexible,
the chain assembled so that said outer plates are disposed in such a way that the direction of burnishing of said burnished holes is disposed outward, and said inner plates are disposed in such a way that the direction of burnishing of said burnished holes is disposed inward.

3. The chain according to claim 2, wherein in the outer links said pins are pressed into the outer plates and in the inner links said bushes are pressed into the inner plates.

4. The chain according to claim 1, wherein the chain is a leaf chain or a silent chain composed of a plurality of plates flexibly connected by pins,
the chain assembled so that outermost plates on both sides of the chain into which said pins are pressed are disposed in such a way that the direction of burnishing of said burnished holes is disposed outward.

5. The chain according to claim 1, wherein the burnished holes are made by press-punching to obtain prepared holes, shaving the prepared holes, and then carrying out multi-step burnishing to the shaved holes.

6. The chain according to claim 5, wherein the burnished holes are chamfered at both ends of the straight holes before multi-step burnishing and after shaving.

7. A method of blanking a hole in a chain plate, comprising the steps of:
forming a substantially straight hole by press-punching and then shaving a trumpet-shaped or reverse-trumpet-shaped prepared hole; and
carrying out multi-step burnishing by inserting a multi-step burnishing punch composed of a plurality of annular convex portions formed at predetermined intervals into said straight hole, thereby improving a smoothness of a hole and generating compressive residual stress in said hole wall.

8. The chain plate hole blanking method according to claim 7, wherein, before burnishing, both ends of the straight hole formed by shaving are chamfered.

9. The chain plate hole blanking method according to claim 7, wherein the multi-step burnishing punch is inserted from a direction that is the reverse of the shaving direction.

10. The chain plate hole blanking method according to claim 8, wherein the multi-step burnishing punch is inserted from a direction that is the reverse of the shaving direction.
